(19) United States
(12) Patent Application Publication
(10) Pub. No.: US 2009/0011828 A1
(43) Pub. Date: Jan. 8, 2009

(54) Device for running copy-protected software

(75) Inventor: Menno Anne Treffers, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/561,993

(22) PCT Filed: Jul. 1, 2004
(86) PCT No.: PCT/IB2004/051083

§ 371 Date: Dec. 23, 2005

(30) Foreign Application Priority Data
Jul. 4, 2003 (EP) 03102000.1

(51) Int. Cl. A63F 9/24; G06F 12/14; H04L 9/08

(52) U.S. Cl. 463/29; 713/190; 380/278

(57) ABSTRACT

The invention relates to a device for running copy-protected software stored on an information carrier (6). It is a object of the invention to increase the hurdle for hackers to make a readable copy of the information carrier (6). To achieve this object a device is provided, comprising: a drive (1) for reading said encrypted graphics data (7) and said encryption data (8, 11, 12), means (9) for decrypting said encrypted graphics data (7) using said encryption data (8, 11, 12) for obtaining decrypted graphics data (16), an application processing unit (4) for running said copy-protected software, a graphics processing unit (10) for processing said graphics data (16), means for opening a secure communication channel (5) between said drive (1) and said graphics processing unit (10) for transferring said decrypted graphics data 16 and/or said encryption data (8, 11, 12) from said information carrier (6) to said graphics processing unit (10).

The present invention relates to a device for running copy-protected software and to a corresponding method for running copy-protected software.

Games are usually distributed on CD-ROM and DVD-ROM discs. PCs but also game consoles such as the PlayStation or Xbox can also use DVD-ROM disc variants. Data for games stored on such discs are often copied without consent of the copyright owner, thus reducing the income of the game publishers. These illegal copies are distributed on recordable discs, and increasingly also via Internet. Thus, game discs need to be protected against copying and against distribution via internet. With current read-out devices copies of the game can be made easily during processing the game.

It is an object of the present invention to provide a device for running copy-protected software which makes it more difficult to copy the software.

This object is achieved according to the present invention by a device as claimed in claim 1 for running copy-protected software comprising encrypted graphics data and encryption data stored on an information carrier, comprising:

a drive for reading said encrypted graphics data and said encryption data,

means for decrypting said graphics data using said encryption data for obtaining decrypted graphics data,

an application processing unit for running said copy-protected software,

a graphics processing unit for processing said decrypted graphics data, and

means for opening a secure communication channel between said drive and said graphics processing unit for transferring said decrypted graphics data and/or said encryption data from said drive to said graphics processing unit.

According to the invention software, preferably game software, stored on an information carrier, e.g. a disc, can be protected against copying by encrypting graphics data. Said software is called copy-protected software, hereinafter. The encrypted graphics data are stored on an information carrier, e.g. an optical disc like a CD or DVD. Encryption data for decrypting the encrypted graphics data are stored on the information carrier, too. Various embodiments of said encryption data are possible. The encryption data can be encrypted itself, or they can be stored as readable encryption data without being encrypted. The mentioned embodiments are described below in more detail.

The information carrier can be located in a disc drive, which reads out the encrypted graphics data and the encryption data from the information carrier. The drive can be an optical drive adapted to read an optical information carrier. An application processing unit is provided for controlling data transfer by means of an application software between sub-systems of the device, such as the drive and the graphics processing unit (GPU). The application processing unit, the drive and the GPU are connected with each other via a communication bus. Not the whole software has to be encrypted to protect it sufficiently, but only a part of the data, which is necessary or at least important for running the software. Advantageously, encrypting only a part of the software reduces time for decryption.

According to the invention only selected data are encrypted. These data are called graphics data, hereinafter. Said graphics data are data processed by a GPU, but the application processing unit does not process or manipulate them to run the software. Said graphics data are adapted to be transferred between said drive and said graphics processing unit. The application software controls the transfer of said graphics data. These graphics data can be texture maps, images, video data or 3D model data.

Thus, the encryption data need not be disclosed to the application software. The encryption data are not visible in the bus system controlled by the application software unit which is an improvement compared to the art. Disclosure of the encryption data to the application software is often the weakest point, when trying to make a system tamper resistant. The disclosed encryption data are not protected and they can be recorded easily together with the encrypted graphics data on another disc.

Further, according to the present invention means for decrypting said encrypted graphics data using said encryption data are provided. The sequence of decrypting the encrypted graphics data using said encryption data on the one hand side and transferring the encrypted graphics data and/or encryption data to the GPU via said secure communication channel on the other hand side can vary.

Graphics data and/or encryption data are transferred via the secure communication channel from the information carrier to the GPU and decrypted graphics data are processed by the GPU. Copying the complete software requires in any case either copying the decrypted graphics data or copying the encrypted graphics data together with the encryption data among other things. Decrypted graphics data are never visible in the non-secure bus system of the read-out device. Decrypted graphics data are transferred between the information carrier and the GPU via the secure communication channel. Thus, copying the decrypted graphics data requires hacking the secure communication channel. Encryption data are also transferred via the same or another secure communication channel. Thus, copying the encryption data also requires hacking a secure communication channel. A secure communication channel can be made arbitrarily secure. Thus, obtaining a readable version of the software using the read-out device can be made arbitrarily difficult.

Techniques for making a secure communication channel are known and will not be described here. For instance, a secure authenticated channel with a public key protocol can be used. The secure communication channel is installed in the ordinary bus system of the device. According to the invention means for opening a secure communication channel are provided.

In a preferred embodiment of the invention means for decrypting said encrypted graphics data are included in a graphics card containing said GPU and the secure communication channel is adapted for transferring said encryption data. In this embodiment of the invention the encrypted graphics data can be transferred via the bus system before they are decrypted by the means for decrypting said encrypted graphics data. The means for decrypting said encrypted graphics data are arranged together with the GPU on, e.g., a graphics card. Graphics card has to be understood in a broad sense comprising any sub-system containing a GPU. In this embodiment of the invention the encryption data can be stored on the information carrier in a readable version. The encryption data are transferred via a secure communication channel between the information carrier and the means for decrypting said encrypted graphics data on said graphics card. In this embodiment the encrypted graphics data can be transferred to the means for decrypting said encrypted graphics data on said graphics card via a non-secure channel.

A session key can be used for implementing a secure communication channel. Data are encrypted at the input of the secure communication channel and are decrypted at the output of the secure communication channel. The session key can change after each re-boot. It has to be noticed that encrypting/decrypting graphics data by means of the encryption key is usually independent of encrypting/decrypting data by means of the session key for the secure communication channel. Even different encrypting algorithms can be used. In this embodiment of the invention the encryption data are encrypted at the information carrier side of the secure communication channel by the session key, and they are transferred via the secure communication channel to the GPU side of the communication channel. Before reaching the means for decrypting said encrypted graphics data the encryption data are decrypted again. Thus, the encryption data are not visible in the bus system. Obtaining the encrypting data requires a cryptographic attack on the secure communication channel. That makes it very difficult to obtain the encryption data.

In another preferred embodiment of the invention means for decrypting said encrypted graphics data are included in said drive and said secure communication channel is adapted for transferring decrypted graphics data. In this embodiment of the invention encrypted graphics data can be decrypted before they are transferred via the secure communication channel between the information carrier and the GPU. The means for decrypting said encrypted graphics data are included in the drive. In this embodiment the encryption key is applied to said encrypted graphics data by the means for decrypting said encrypted graphics data and the resulting decrypted graphics data are transferred via a secure communication channel to said GPU. In this embodiment encrypted graphics data are decrypted by means of the encryption data on the information carrier side of the secure communication channel. The resulting decrypted graphics data are encrypted and decrypted by a session key of the secure communication channel. In this embodiment of the invention the encryption key has not to be transferred separately. This can improve speed for running the software.

As mentioned above the encryption data can be encrypted themselves which further improving security. Preferably, said encryption data contain key locker data and hidden code data, and means for unlocking said key locker data by said hidden code data are provided in said drive for obtaining encryption key data for decrypting said encrypted graphics data. In this embodiment of the invention the encryption key data are hidden in a key locker. A hidden code can be used to unlock the key locker data. Preferably, the means for unlocking are included in the drive. Unlocking the key locker data is also a type of decrypting. The hidden code can also be stored on the information carrier. In this embodiment of the invention the encryption data are stored in an encrypted form on the information carrier increasing the hurdle for copying the software even more. In another embodiment of the invention the hidden code is stored in an integrated circuit (IC) attached to said information carrier. These chip-in-discs are more expensive but also more tamper resistant, because the IC has to be reverse-engineered to obtain the hidden code. The hidden code can also be distributed separately from the information carrier, e.g. by a smart card. The encryption key data are a special case of the encryption data described above, and they can be used in the same way as the encryption data in the above mentioned embodiments.

In another preferred embodiment of the invention encryption key data are calculated combining encryption data stored on said information carrier and secret information stored inside the drive. An advantage of this embodiment is that the information carrier can be read out only by certain drives containing said secret information.

The claimed device is preferably a PC or a game console such as the PlayStation or Xbox.

The object of the invention can also be achieved by a method for running copy-protected software as claimed in claim 6. This method can be carried out by a described above.

The invention will now be explained in more detail with reference to the drawings, in which:

FIG. 1 shows a schematic view of the architecture of a game console,

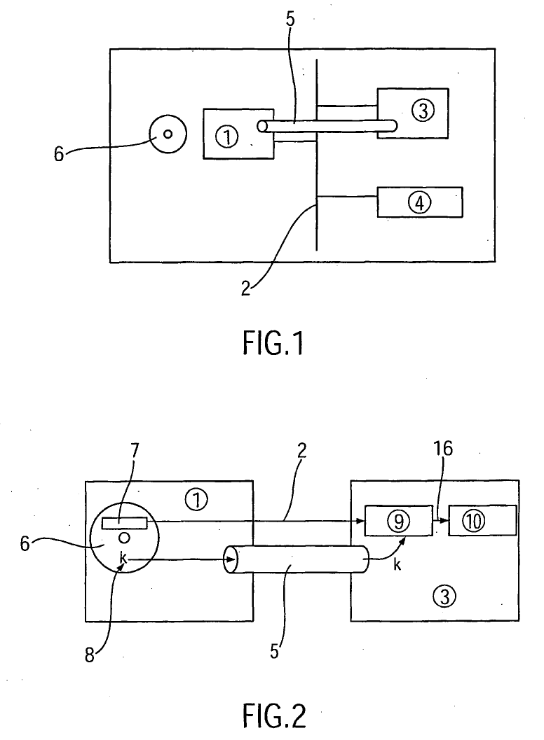

FIG. 2 shows a schematic view of a first embodiment of the invention,

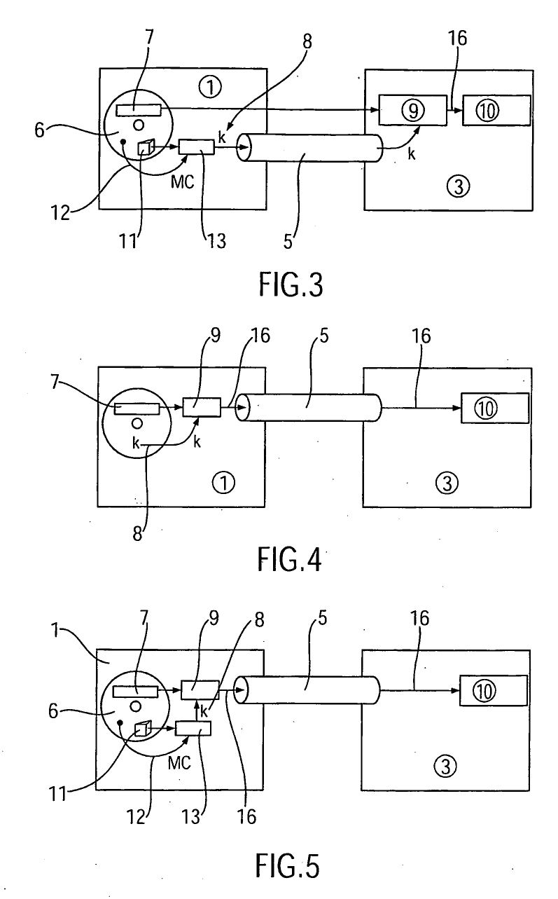

FIG. 3 shows a schematic view of a second embodiment of the invention,

FIG. 4 shows a schematic view of a third embodiment of the invention,

FIG. 5 shows a schematic view of a fourth embodiment of the invention, and

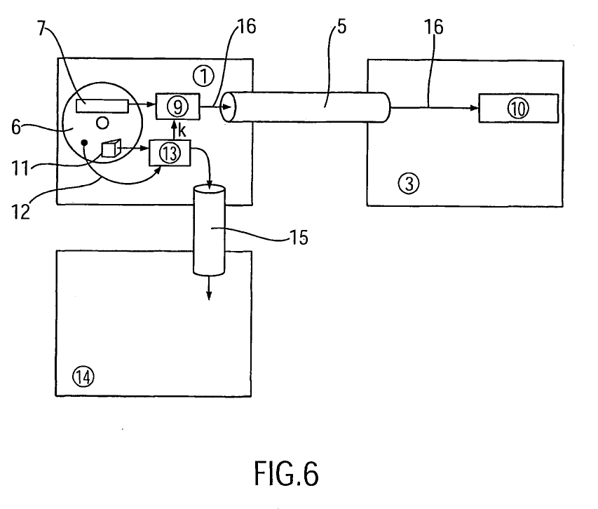

FIG. 6 shows the schematic view of an embodiment of the invention that combines the second and fourth embodiment.

The architecture of a game console or PC schematically depicted in FIG. 1 contains an optical disc drive 1, which is connected via a bus 2 (a PCI bus in a PC) with a graphics card 3 and an application processing unit 4 for processing a software. The optical disc drive 1 and the graphics card 3 contain means for opening a secure communication channel 5 between them. The secure communication channel 5 uses the existing bus system 2. Techniques for making secure communication channels 5 are known. One method is to use public key protocols, but also protocols that use symmetric keys are possible. The optical disc drive 1 performs the encryption and the graphics card 3 performs the decryption of a message by means of a session key for the secure communication channel 5. The message is transferred under control of the application software.

Graphics data are encrypted and stored in encrypted form on a disc 6 to protect the game form being copied. Not all data of the game have to be encrypted but only some data necessary for playing the game. Data are selected for encrypting, which are not modified or manipulated by the application software. The data to be encrypted can be texture maps, 3D models, video data or a still picture. Said data shall be called encrypted graphics data 7. For decrypting the encrypted graphics data 7 encryption key data 8 are provided.

According to a first embodiment of the invention, shown in FIG. 2, the disc 6 contains the encrypted graphics data 7 and the encryption key data 8 for decrypting the graphics data 7. Encrypted graphics data 7 on the disc 6 are read out by the optical disc drive 1 and sent via the bus system 2 to the graphics card 3, where the encrypted graphics data are decrypted by means of the encryption key data (k) 8. The encrypted graphics data 7 are transferred by the application software 4 from the graphics card 1 to the disc drive 3. The encrypted graphics data 7 can be transferred to the graphics card 3 via the PC hardware bus system without the need for a secure communication channel 5.

The encryption key data (k) 8 for decrypting said encrypted graphics data 7 are stored on the disc 6, too, and transferred to the graphics card 3 via the secure communication channel 5. Thus, the encryption key data (k) 8 are encrypted on the optical drive 1 by means of the session key for the secure communication channel 5 as described above. It is sent within the hardware bus system 2 of the game console to the graphics card 3 under control of the application software 4. This prevents the encryption key data (k) 8 from being copied and distributed together with the game including the encrypted graphics data 7, for instance in the Internet.

After reaching the graphics card 3, the encryption key itself is decrypted by means of the session key for the secure communication channel 5 and supplied to means 9 for decrypting said encrypted graphics data. The means 9 for decrypting are formed as decryption software on the graphics cards 3. The decryption software enables the console to decrypt the encrypted graphics data 7 transmitted via the bus system 2 by means of the transmitted encryption key data 8. Decrypted graphics data 16 are supplied to the graphics processing unit (GPU) 10 to process graphics required for the game.

The encryption key data 8 stored on the disc 6 can be made invisible to ordinary PCs. Therefore it is possible to copy the disc 6 with the encrypted graphics data 7, but it is impossible to copy the encryption key data 8. Thus, a copy of the disc provides a duplicate with encrypted data but without the encryption key data 8. Such a copy can not be used.

One possibility to hide the encryption key data 8 is an optical recording trick such as the hidden code described in the U.S. Pat. No. 6,157,606. A weaker possibility is to store a secret key k1 inside the optical drive 1 and write a non-secret key k2 on the disc 6. The key k2 can be read by normal optical drives 1. A combination k1+k2 by means of a hash-function retrieves the encryption key data 8, which are needed by the graphics card 3. A disadvantage of this method is that the key k2 can be copied and the disc 6 can play in any game console, but not in an ordinary PC.

In a second embodiment of the invention, according to FIG. 3, there is a further hurdle for a hacker to copy a game stored on the disc 6. The encryption key data 8 are stored in an encrypted data area on the disc called key locker data (KL) 11. A key locker key is hidden on the disc, for instance, using hidden code data (HC) 12. The optical drive 1 provides means 13 for unlocking the key locker data 11 with the hidden code data 12. Hidden code data 12 should be used, which cannot be recorded.

In this embodiment of the invention the key locker data 11 provide the encryption key data 8 in a coded form, which can be unlocked with the hidden code data 12. The unlocked encryption key data 8 are than transmitted via the secure communication channel 5 to the graphics card 3, where they are supplied to the means 9 for decrypting the encrypted graphics data 7. The decrypted graphics data 16 are transmitted to the GPU 10.

In a third embodiment of the invention, according to FIG. 4, the first means 9 for decrypting are provided in the optical drive 1 of the console. The encryption key data 8 and the encrypted graphics data 7 are read out by the optical drive 1 and supplied to the means 9 for decrypting. The encrypted graphics data 7 are decrypted and supplied to one end of the secure communication channel 5. At that one end of the secure communication channel 5 the decrypted graphics data 16 are encrypted by means of the session key for the secure communication channel 5. Afterwards they are sent under control of the application software 4 via the secure communication channel using the bus system 2 to the graphics card 3, where decryption by the session key takes place. The decrypted graphics data 16 are supplied to the GPU 10 of the graphics card 3 and graphics are processed.

In a forth embodiment of the invention, according to FIG. 5, the means 9 for decrypting are also provided in the optical drive 1. Encrypted graphics data 7 stored on the disc 6 are read out by the optical drive 1 and are decrypted by the means 9 for decrypting. The decrypted graphics data 16 are supplied to the secure communication channel 5 at its one side, they are encrypted again this time by the session key for the secure communication channel 5 and transmitted via the secure communication channel 5 under control of the application software 4 to the other end of the secure communication channel 5 to be decrypted on the graphics card 3 and supplied to the GPU 10.

In this embodiment of the invention an additional hurdle, known from the second embodiment of the invention, is installed. The encryption key data 8 are not stored on the disc 6 in a readable version, but the encryption key data 8 are locked, i.e. encrypted in the key locker data 11. Hidden code data 12 for unlocking the key locker data 11 are also stored on the disc 6. The hidden code data 12 cannot be recorded or copied. The key locker data 11 are unlocked by means 13 for unlocking. This results in an additional burden for the hacker to copy the game and distribute the game via internet. The console requires the means 13 for unlocking the key locker data 11.

In FIG. 6 a combined architecture is depicted, which comprises the second and fourth embodiment of the invention described above.

Essential for the combined architecture are on the disc side the encryption key data 8 stored on the disc 6 in encrypted form, the key locker data 11 to be locked and unlocked by means of the hidden code data 12. The combined architecture contains on the drive side means for reading the hidden key, means 13 for unlocking the key locker data 11 with the hidden code data 12, means 9 for decrypting the encrypted graphics data 7 with the encryption key data 8 and means for opening or creating secure authenticated channels as a kind of a secure communication channel 5. In this embodiment a ROM mark is used as hidden code data 12. The key locker data 11 are locked with the ROM mark 12. Encrypted graphics data 7 stored on the disc 6 can be decrypted with the encryption key data 8 locked in the key locker data 11. The key locker data 11 contain a license string or other data needed by the kernel or bias 14 to run the game. The license string is transmitted via a second secure authenticated channel 15 to the bias or kernel. The license string is an additional security means. The disc 6 containing encrypted graphics data 7, key locker data 11 and a ROM mark 12 is protected against hacker attacks creating a working copy of an original game disc.

The ROM mark is sensitive for inherent accuracy losses, when peeling an original disc and making a new stamper.

If a hacker obtains an ISO image of the disc 6, i.e. a single file that contains all information needed to create the disc 6 including the file system structures and all files that must be copied on the disc, it is still necessary for the hacker to obtain encryption key data 8 or encrypted key locker data 11 and a matching ROM mark 12. In principle formatters (equipment that controls a laser beam recorder) can generate a glass master, which can be used to create stampers including the ROM mark. A line of defense would be to restrict the access to formatters.

Also some DVD recorders can create ROM marks 12. A line of defense is to use ROM marks 12 that cannot be recorded but only mastered. If it is possible for a hacker to obtain an ISO image of the disc 6, the key locker data 11 and the blank recordable disc with a mastered ROM mark 12 at the correct location and if he obtains a method to decrypt the key locker data 11, the key locker 11 can still be located in an area on the disc 6 that existing DVD recorders do not write to. That prevents hackers from copying the disc 6.

Hacking needs in any way the readable key locker data 11. The key locker data 11 must not be provided to another sub-system such as the graphics card 3, kernel 14 or application software 4 to protect it. Thus, the encryption key data 8 are never visible outside the optical drive 1. Secrets needed by the kernel 14 or the graphics card 3 are only provided by the secure communication channel 5. As a result the hacker will not be able to retrieve the complete key locker data 11 by compromising another sub-system. Key locker data 11 can then be extracted only by hacking the optical drive 1. The value of the ROM mark 12 and the encryption key data 8 itself must be hidden from the firmware of the optical drive 1. ROM mark 12 detection and decryption can be done in the hardware in a single IC. Therefore it is not sufficient to hack the firmware of the optical drive 1, but the optical drive IC has to be re-engineered. That makes it much more difficult for the hacker to copy the disc 6.

The invention deals with a method for running copy-protected games on a console making it difficult for a hacker to copy the game. Some graphics data 7 need not be manipulated by the application software during playing the game. Said graphics data 7 are stored in an encrypted form on the disc 6. Data for the corresponding encryption key data 8 are also stored on the disc 6. A secure communication channel 5 is established between the graphics card 3 and the optical drive 1. Either the encryption key data 8 or the decrypted graphics data are transferred via the secure communication channel 5 from the disc drive 1 to the graphics card 3. Thus, the encryption key data 8 are not disclosed to the application software 4 making it more difficult for a hacker to make a readable copy of the disc 6.

1. Device for running copy-protected software comprising encrypted graphics data (7) and encryption data (8, 11, 12) stored on an information carrier (6), comprising:
a drive (1) for reading said encrypted graphics data (7) and said encryption data (8, 11, 12),
means (9) for decrypting said encrypted graphics data (7) using said encryption data (8, 11, 12) for obtaining decrypted graphics data (16),
an application processing unit (4) for running said copy-protected software,
a graphics processing unit (10) for processing said graphics data (16),
means for opening a secure communication channel (5) between said drive (1) and said graphics processing unit (10) for transferring said decrypted graphics data (16) and/or said encryption data (8, 11, 12) from said drive (1) to said graphics processing unit (10).

2. Device as claimed in claim 1, characterized in that said means (9) for decrypting said encrypted graphics data are included in a graphics card containing said graphics processing unit and said secure communication channel (5) is adapted for transferring said encryption data (8, 11, 12).

3. Device as claimed in claim 1, characterized in that said means (9) for decrypting said encrypted graphics data are included in said drive and said secure communication channel (5) is adapted for transferring said decrypted graphics data (16).

4. Device as claimed in claim 1, characterized in that said-encryption data (8, 11, 12) contain key locker data (11) and hidden code data (12) and in that means (13) for unlocking said key locker data (11) by said hidden code data (12) are provided in said drive for obtaining encryption key data (8) for decrypting said encrypted graphics data (7).

5. Device as claimed in claim 1, characterized in that it comprises a game console.

6. Method for running copy-protected software, wherein said copy-protected software is stored on an information carrier (6) and said copy-protected software contains encrypted graphics data (7) and encryption data (8, 11, 12), comprising the steps of:
reading said graphics data (7) from said information carrier (6),
reading said encryption data (8, 11, 12) from said information carrier (6),
decrypting said encrypted graphics data (7) using said encryption data (8, 11, 12) for obtaining decrypted graphics data (16),
transferring said decrypted graphics data (16) and/or said encryption data (8, 11, 12) via a secure communication channel (5) from said drive (1) to a graphics processing unit (GPU) (10),
processing said decrypted graphics data (16) by a graphics processing unit (10), and
processing said copy-protected software by an application processing unit (4).

7. Method as claimed in claim 6, characterized by the steps of
decrypting said encrypted graphics data (7) using said encryption-data (8, 11, 12), and
transferring decrypted graphics data (16) to a graphics processing unit (3) via a secure communication channel (5).

8. Method as claimed in claim 6, characterized by the steps of
transferring encryption data (8, 11, 12) via a secure communication channel (5) to a graphics processing unit (3),
transferring said encrypted graphics data (7) to said graphics processing unit (3), and
decrypting said encrypted graphics data (7) using said encryption data (8).

9. Method as claimed in claim 6, characterized in that said encryption data (8, 11, 12) contain key locker data (11) and hidden code data (12) and in that the step of reading out said encryption data comprises the steps of
reading hidden code data (12) from said optical information carrier (6),
reading key locker data (11) from said optical information carrier (6), and
unlocking said key locker data (11) using said hidden code data (12) for obtaining an encryption key (8) for decrypting said encrypted graphics data (7).
